(19) United States
(12) Patent Application Publication
(10) Pub. No.: US 2008/0266133 A1
(43) Pub. Date: Oct. 30, 2008

(54) Method and Arrangement for Communicating with a Meter Peripheral Using a Meter Optical Port

(75) Inventor: Warren Thomas Martin, Lafayette, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: LANDIS+GYR,INC., Lafayette, IN (US)

(21) Appl. No.: 11/861,710

(22) Filed: Sep. 26, 2007

Related U.S. Application Data
(60) Provisional application No. 60/847,903, filed on Sep. 28, 2006.

(51) Int. Cl. G08B 23/00

(52) U.S. Cl. 340/870.02

(57) ABSTRACT

A utility meter adapted to communicate with a device external to the utility meter comprises a meter housing, a first port, a second port and a processor. The first port is adapted to receive signals transmitted from outside the meter housing. The second port is connected to a communications module associated with the meter. The communications module is adapted to communicate with the device external to the utility meter. A processor is connected to the first port and the second port. The processor is configured to pass signals received at the first port to the communications module through the second port.

### CROSS-REFERENCE TO RELATED APPLICATIONS

This application claims the benefit of earlier filed U.S. provisional application No. 60/847,903, filed Sep. 28, 2006.

### FIELD

This application relates to the field of utility metering, and more particularly, to utility meters having external communications capability.

### BACKGROUND

Utility meters typically include a metering circuit that is capable of measuring some aspect of a consumed commodity. For example, in electricity meters, a metering circuit measures electrical energy delivered to a customer or load. Utility meters increasingly have communication capabilities, allowing the utility meter to send data to and receive data from a remote location. Accordingly, many modern utility meters have been enhanced by mating them with add-on or integrated communications modules of various technologies. These communications modules allow data to be transported from the metering device to a communication network. One example of a communication module is the automatic meter reader (AMR) board found in many modern electricity meters.

In many instances, a communication module will include a meter communications port that connects to one of the communication ports of the utility meter (e.g., an auxiliary communications port). Connecting the communication ports of the utility meter and the communication module provides a serial communication channel allowing information to be transported between the two devices (i.e., the meter microprocessor and the communication module/device).

The communication module typically must be preconfigured to set communication parameters such as baud rate, data word length, stop bits and other functions such as updates to firmware and so on, to match the parameters of the utility meter's communication port before the two devices can communicate. The communication module may also need to be configured to allow connection to the communication network prior to being put into service. Many communication modules connect to the meter using the same communication port that is used for configuration of the communication module. Alternatively, the communication module may include a port that is dedicated to configuration. In either arrangement, configuration of the communications module is typically accomplished by pre-configuration of the communication module prior to installation and connection of the communication module to the metering device. Configuration after installation is typically not practical, as gaining access to the module's configuration port is typically difficult once the meter is in service and the meter cover blocks access to the communication module. Furthermore, the presence of high voltage inside an in service meter generally prohibits working on a meter with the cover removed.

In view of the foregoing, it would be advantageous to provide a utility meter having a communications module that does not need to be pre-configured before installation in the meter. In would also be advantageous if the configuration port of the communications module could be accessed with the meter cover installed and the meter in service, allowing the communication module to be configured or re-configured while it remains inside of the meter without the need to take the meter out of service.

### SUMMARY

A utility meter adapted to communicate with a device external to the utility meter comprises a meter housing, a first port, a second port and a processor. The first port is adapted to receive signals transmitted from outside the meter housing. The second port is connected to a communications module associated with the meter. The communications module is adapted to communicate with the device external to the utility meter. A processor is connected to the first port and the second port. The processor is configured to pass signals received at the first port to the communications module through the second port.

In at least one embodiment, the processor is configured to operate in either a first mode or a second mode. In the first mode, the processor delivers metrology data to the communications module through the second port. In the second mode, the processor passes configuration signals received at the first port to the communications module via the second port. In the second mode of operation, when data is are passed from the first port to the second port, the processor does not parse the data.

In association with the foregoing, a method of operating a utility meter as described above is disclosed herein. The method comprises delivering metrology data to the communications module through the second port. The method further comprises sending the metrology data delivered to the communications module to a communications network. In addition, the method comprises passing configuration signals received at the first port to the communications module through the second port, wherein the communications module is configured using the configuration signals.

### BRIEF DESCRIPTION OF THE DRAWINGS

FIG. 1 shows a block diagram of an exemplary utility meter arrangement in communication with a remote communication device;

FIG. 2 shows a further detailed view of the block diagram of FIG. 1, the meter including a memory, a processor, a display, and a transceiver;

FIG. 3 is a diagram representing the meter of FIG. 2 in a normal mode of operation;

FIG. 4 is a diagram representing the meter of FIG. 2 in a pass-thru mode of operation; and

FIG. 5 is a flowchart showing operation of the meter in the pass-thru mode of FIG. 4.

### DESCRIPTION

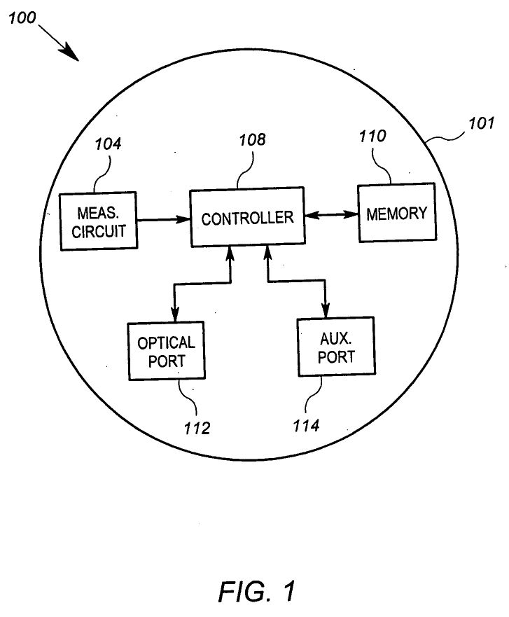

With reference now to the drawings, FIG. 1 shows an exemplary utility meter 100 configured for operation according to at least one embodiment of the present invention. The utility meter 100 includes a measurement circuit 104, a memory 110, a processor/controller 108, a first port 112, and a second port 114, all provided within a meter housing 101. It will be appreciated that the utility meter 100 may optionally include other devices typically found in utility meters. For example, the utility meter may include additional communication circuitry, an electronic or mechanical display, and/or other peripheral devices commonly available in utility meters.

The measurement circuit 104 is a circuit that generates metrology data. The metrology data may be in the form of digital signals, such those as used within processing circuitry, or may include pulses representative of a particular quantity of commodity consumed. For example, in water and gas meters, circuitry connected to flow metering devices generate pulse signals, each of which represents a certain amount of flow. In electricity meters, the measurement circuit 104 may include one or more processing devices that calculate energy consumption data from measured current and voltage signals.

Metrology data from the measurement circuit 104 is delivered to the controller 108, which processes the metrology data and/or distributes the data to other meter components. For example, metrology data may be delivered from the controller 108 to the memory, the first port 112 or the second port 114. In addition, the controller is configured to receive signals from the first port 112 and the second port 114.

The first port 112 in the embodiment of FIG. 1 is an optical port having an optical transceiver (not shown) associated with the optical port. Accordingly, the optical port 112 is configured to receive optical signals from outside the meter housing 101 and convert the optical signals into electrical signals. In addition, the optical port 112 is configured to convert electrical signals into optical signals and transmit the optical signals outside of the meter housing 101. To this end, the optical port 112 includes a window (not shown) in the housing 101 allowing optical signals transmitted outside of the meter to be received within the meter and allowing optical signals transmitted within the meter to be delivered outside of the meter. The optical transceiver may be provided on the meter board as the controller 108, or may be separate from the controller board within the meter housing. It will be recognized that optical ports are known in utility meters, and those of skill in the art will recognize various different types of optical ports that may be utilized in association with the embodiments disclosed herein.

The second port 114 is an auxiliary meter port. The auxiliary meter port 114 is connected to the controller 108, allowing electrical signals to be passed back and forth between the controller 108 and the auxiliary port 114. In at least one embodiment explained in further detail below, the auxiliary port 114 acts as a communications port for the meter 100 and is connected to a communications device (not shown in FIG. 1). By connecting the auxiliary port 114 to a communications device, the meter 100 is allowed to communicate with another device or network located outside of the meter. For example, the communications device may be an automatic meter reader (AMR) board providing communications with an AMR network. Accordingly, in this embodiment the auxiliary port 114 provides a link in the communication chain between the microcontroller 108 and the AMR network.

The memory 110 in the exemplary embodiment of FIG. 1 may be a non-volatile memory that retains data even in the absence of electrical bias power. Thus, the non-volatile memory 14 may be an electrically erasable programmable read-only memory (“EEPROM”). The non-volatile memory 14 is operably coupled to communicate data to and/or from other meter components via the controller 16.

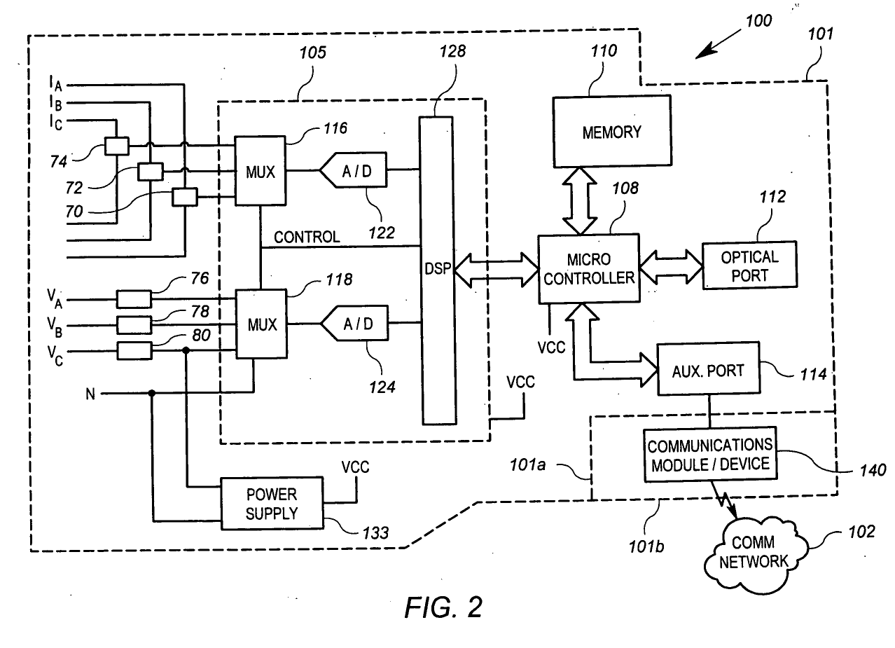

FIG. 2 shows a more detailed view of an exemplary electricity meter 100 configured for use according to at least one embodiment of the present invention. The electricity meter 100 shows in further detail one example of the meter 100 shown in FIG. 1.

Referring now to FIG. 2, a schematic diagram of an exemplary meter suitable for practicing the present invention is shown. For purposes of explanation and example only, the meter of FIG. 2 is shown as an electrical utility meter for monitoring three-phase electrical power. However, the principles disclosed herein are applicable to other types of meters, electrical meters and otherwise.

In FIG. 2, the exemplary meter 100 is a meter intended to, among other things, measure power consumption by a load, not shown, connected to an electric utility, not shown. The exemplary meter 100 includes a measurement circuit comprising polyphase current sensors 70, 72 and 74, polyphase voltage sensors 76, 78 and 80, and a conversion circuit 105. The meter 100 further includes a processor or microcontroller 108, a memory circuit 110, a first port 112, and a second port 114 connected to a communication device 140. The conversion circuit 105 comprises a first multiplexer 116, a second multiplexer 118, a first analog-to-digital (“A/D”) converter 122, a second A/D converter 124, and a digital signal processor (“DSP”) 128. It will be noted that a three-phase electrical utility meter is given by way of example only. Those of ordinary skill in the art may readily adapt the inventive aspects of the disclosed embodiment to other types of meters, such as single phase or network meters.

The meter 100 further includes a power supply 133 that is configured to generate bias power for the conversion circuit 105, the controller 108, the memory circuit 110, and any other elements of the meter 100 requiring bias power. Such a power supply 133 may suitably be a switched mode power supply circuit that converts line voltage received from one of the mains electrical power lines to suitable DC bias voltages. Such circuits are known to those of ordinary skill in the art. In one example, the power supply 133 may be connected to the mains electrical power lines and generate bias power for the measurement circuit. However, the power supply 133 may, for example, alternatively derive power from batteries, light sources or the like. In accordance with embodiments of the present invention, the power supply 133 provides the power necessary to allow data communication between the measurement circuit 104 and the non-volatile memory 110.

The current sensors 70, 72 and 74 are each connected to receive signals indicative of the current flowing through one phase of a three phase power line (i.e., phase A, phase B, and phase C). The current sensors 70, 72 and 74 of the exemplary embodiment described herein preferably each include transformers (not shown in FIG. 2), which are advantageously situated to detect current on each respective phase of the power line. The current sensors 70, 72 and 74 are further connected to the conversion circuit 105 through the first multiplexer 116.

The voltage sensors 76, 78 and 80 are each connected to the respective phase of the power line (i.e., phase A, phase B, and phase C) to obtain a voltage measurement therefrom. To this end, the voltage sensors 76, 78 and 80 may suitably comprise high resistance voltage dividers. Alternatively, the voltage sensors 76, 78 and 80 may be potential transformers. The voltage sensors 76, 78 and 80 are further connected to the conversion circuit 105 through the second multiplexer 118.

The conversion circuit 105 is a circuit operable to receive polyphase voltage and polyphase current measurement signals and generate digital signals therefrom, the digital signals including a power consumption signal and voltage and current signals. In the exemplary embodiment described herein, the conversion circuit 105 comprises first and second multiplexers 116 and 118, respectively, the first and second A/Ds 122 and 124, respectively, and the DSP 128. The above listed components of the conversion circuit 105 may suitably be incorporated onto a single semiconductor substrate.

The controller 108 is operably configured to execute programming instructions, receive the digital signals from the conversion circuit 105, monitor and record power consumption using the digital signals, and analyze the digital voltage and current measurement signals and associated phase angle data to determine whether one or more measurement errors is present. The controller 108 generally includes firmware, or in other words, an integrated memory into which programming instructions are stored. Alternatively, the programming instructions may be stored in the memory 110.

The memory 110 is configured to store data, and the controller 108 is configured to deliver data to the memory or retrieve data from the memory 110. Accordingly, software routines for the controller 108, metrology data, and other data that may be useful for the meter 100 may be stored in the memory 100.

As discussed above, the first communication port 112 may be provided as an optical port. The optical port provides for communication via an optical link between a device external to the meter 100 and the controller 108. Communications through the meter optical port are provided using a meter protocol having a predefined baud rate, data word length, stop bits, etc. The meter optical port may be used for numerous different communications between the meter and the exterior of the meter, such as meter reading, meter programming, etc.

As also discussed above, the meter's second port 114 is an auxiliary port which is connected to the communications module 140. This port 114 provides an electrical link allowing communication between the controller 108 and the communications module 140. Communications between the meter controller 108 and the communications module 140 are generally provided using the meter protocol.

The communications module 140 may be provided internal or external to the meter housing 101. Accordingly, the dotted line 101 representative of the meter housing is shown in two positions relative to the communications module 140 in FIG. 2. In particular, the dotted line portion 101a represents an arrangement where the communications module 140 is outside of the meter housing 101. The dotted line portion 101b represents an arrangement where the communication module 140 is inside the meter housing 101.

The communications module 140 provides for communication between the meter and another entity external to the meter, such as a communications network 102. For example, in at least one embodiment, the communications module 140 may be an AMR board and the communications network 102 may be an AMR network. Communications between the communications module 140 and the communications network 102 are provided according to a network protocol having a predefined baud rate, data word length, stop bits, etc.

The communications module 140 may include a transceiver circuit configured to receive a signal from an external entity, such as network 102, and deliver the received signal to the processor 108 through the auxiliary port 114. The transceiver circuit is also configured to transmit a signal received from the processor 108 through the auxiliary port 114 and to the external entity, such as network 102. Accordingly, the transceiver may be, for example, an RF transceiver operable to perform the above-described functions. However, it will be recognized that numerous other transceivers may be utilized, such as transceivers for power line communications, phone line communications, or other types of communications used in the art.

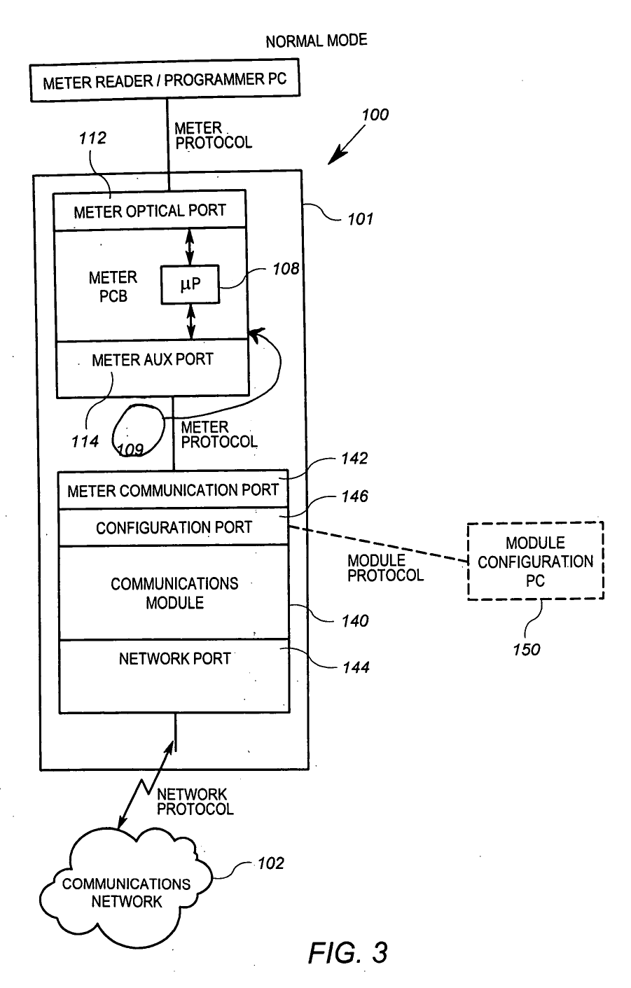

With reference now to FIG. 3, one embodiment of a utility meter is shown where the communications module 140 is connected to the auxiliary port 114 of a meter 100. As shown in FIG. 3, the optical port 112 and the auxiliary port 114 are both provided on a printed circuit board 109 of the utility meter 100, which board may also carry the processor 108 or other meter circuitry. Both the printed circuit board 109 and the communications module 140 are provided within the meter housing 101 in the embodiment of FIG. 3.

The communications module 140 in FIG. 3 includes a meter communication port 142 which is connected to the meter auxiliary port 114. As mentioned previously, signals are transmitted and received between the meter auxiliary port 114 and the meter communications port 142 via a meter protocol. An electrical connection, such as a cable, is provided between the meter auxiliary port 114 and the communication module's meter communication port 142.

In addition to the meter communications port 142, the communication module 140 also includes a network port 144. Signals are transmitted to the communications network 102 and received from the communications network through the network port 144. As mentioned previously, these signals are transmitted and received according to a certain network protocol which the communication module must comply with in order to effectively communicate with the network. For example, the network may require communication using ANSI protocol with certain baud rate, data word length, stop bits, etc. Signals between the communication module 140 and the communications network may be communicated by any of various means used in the art, such as RF communication, power line communication, telephone line communication, or other means of communication.

In addition to a meter communication port 142 and a network port 144, the communication module 140 may also be equipped with a configuration port 146. If a configuration port 146 is provided, this is the port that connects to a computer for configuration of the communications module 140. In FIG. 3, a module configuration PC 150 is shown connected to the configuration port 146. The module configuration PC 150 is shown in dotted lines here because the module configuration PC 150 is typically used to configure the communications module 140 before it is installed in the meter. Connection between a module configuration PC 150 and the configuration port is difficult once the communications module 140 is installed within the meter housing 101 unless the configuration port 146 is equipped with a wireless transceiver, such as an RF transceiver. Accordingly, the meter cover 101 would normally need to be removed to access the configuration port 146 of the communications module.

In many instances, the communications module 140 is not equipped with a configuration port 146. In the absence of a configuration port 146, the communications module 140 may be configured using the meter communication port 142. Again, in this embodiment configuration of the communications module 140 typically occurs before the communications module 140 is installed in the meter 100, since the meter communication port 142 is connected to the meter auxiliary port 114 when the communications module 140 is installed in the meter 100, and it is difficult to access the meter communications port 142 inside the meter housing 101.

In operation, the meter processor 108 is configured to operate in two different modes including a normal mode and a pass-thru mode. Normal mode operation is represented in FIG. 3. When the meter operates in the normal mode, the processor 108 receives information and reports information to and from either the optical port 112 or the meter auxiliary port 114 using the meter's standard metering protocol. As set forth above, this protocol is generally a meter manufacturer defined or industry standard ANSI protocol for metering devices.

When information is received at the meter optical port 112 in the normal mode, the information is passed on to the processor 108 where it is parsed, causing the processor to perform certain actions based on the received information. For example, data received at the optical port 112 may cause the processor to deliver instructions to other meter devices, such as, for example, delivering certain received data to the meter memory or delivering display instructions to a meter display (not shown).

The processor 108 also communicates with the communications module 140 in the normal mode via the meter's auxiliary port 114. In particular, metrology data from the processor 108 is delivered to the communications module 140 when the meter operates in the normal mode. The communications module 140 then passes this metrology data on to the communications network 102. When the communications network is an AMR network, the AMR company is able to track the consumer's usage via the metrology data.

FIG. 3 also shows a device 160 in communication with the meter optical port 112. The device 160 may be, for example, a meter reader or a meter programmer computer. Accordingly, it will be recognized that the meter optical port 112 may be accessed to allow a meter reader to obtain consumption data from the meter. Optical port 112 is also a typical location for data to be passed on to the meter to facilitate meter service such as meter programming, software updates, re-configuration, or adjustment to other meter control operations.

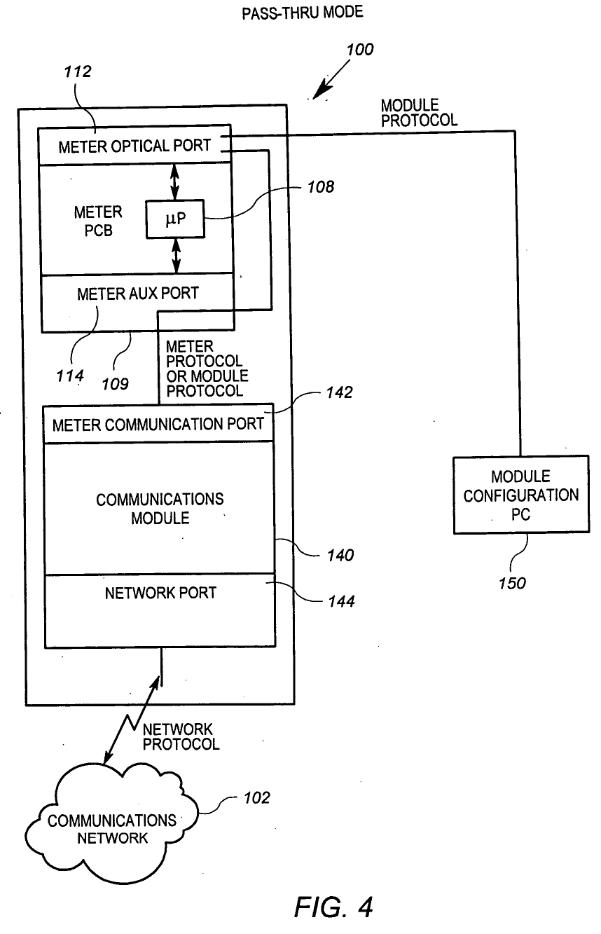

With reference now to FIG. 4, operation of the meter 100 is represented in a pass-thru mode. In the pass thru mode the processor 108 in the meter 100 serves as a link layer gateway, passing the information between optical port 112 and the auxiliary port 114 without further parsing the information. This results in an arrangement where data effectively flows from the meter optical port 112 directly to the communications module 140 via the meter auxiliary port 114, as shown in FIG. 4, without parsing of the data. With this arrangement, a point-to-point communication medium is provided between the meter optical port 114 and the communications module 140, allowing the communications module 140 to be read and configured through the optical port 114 without the need to remove the meter from service or removal of the meter cover 101. The module configuration computer 150 is also shown in FIG. 4 in communication with the meter optical port 114. In the pass-thru mode, signals from the module configuration computer 150 are passed from the optical port to the meter aux port 114, which is connected to the meter communications port 142 of the communications module (which may also be the configuration port of the communications module 140, as discussed above). Thus, when the microprocessor is in the pass-thru mode, the configuration port of the communications module may be accessed, allowing the communications module to be configured or reconfigured without removal of the meter cover.

The default condition for meter operation is the normal operation mode. However, the pass-thru mode can be initiated from the optical port using a unique password. The password generally includes a requested valid baud rate, a requested timeout time, a data format and module password. Upon receipt of a valid password via the optical port 112, the microprocessor enters the pass-thru mode.

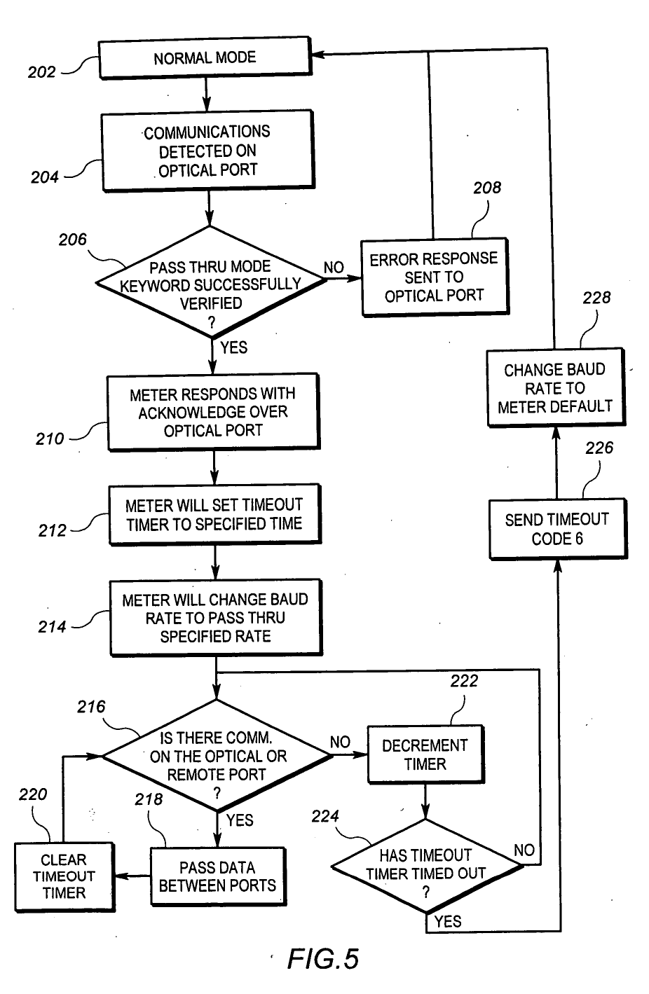

FIG. 5 provides a flow chart of meter operation in the pass-thru mode. As shown in FIG. 5, the processor 108 normally operates in the normal mode, as shown in step 202. However, in step 204, the processor 108 detects communications on the optical port 114. In step 206, the processor determines whether the detected communications amount to a valid password for the pass-thru mode. If the communications on the optical port is not an attempted password, the processor returns to the normal mode. Also, if the password is invalid for some reason, the processor sends an error message to the optical port in step 208, informing the transmitting device that the password is invalid.

If a valid password is received at the optical port, the processor proceeds to step 210 where an acknowledgement is sent to the optical port, informing the transmitting device that the password has been accepted. The processor then sets the timeout to the specified time in step 212 and sets the baud rate to the specified pass-thru rate in step 214. The meter 100 and its processor 108 are now set to operate in the pass-thru mode.

In step 216 the processor determines whether any signals are being received from the optical port 112 or the auxiliary port 114. If signals are being received, the processor proceeds to step 218 where the received data is passed from the optical port 112 to the auxiliary port 114 (and thus the communications module 140) or from the auxiliary port 114 to the optical port. This passing of data is made without the processor parsing the data. In other words, in the pass-thru mode, data passes directly from the optical port 112 to the auxiliary port 114, or vice-versa, without the data being changed or analyzed by the microprocessor. When data passes between the ports in step 218, the timeout timer is cleared, and the processor 108 again looks for data on the optical port 112 or the auxiliary port 114 in step 216.

If no data is being sent over the optical port 112 or the auxiliary port 114, the processor decrements the timer in step 222 and checks to see if the timer has timed out in step 224. If the time has not timed out, the processor returns again to step 216 to look for data being sent over the optical port or auxiliary port. However, once the timer times out, the processor moves to step 226 where a timeout code/message is sent to the optical port, and step 228 where the baud rate is changed and the meter generally returns to a default operation, exiting the pass-thru mode. In particular, at step 202, the meter returns to normal mode operation in the default situation. Thus, the timeout timer is used to monitor the two-way communication of the optical port and remote port while the processor operates in the pass-thru mode. Once there is a lack of communication on the ports and the timer times out, the meter will exit the pass-thru mode and revert back to normal meter protocol communication mode and its default baud rate.

The foregoing embodiments provide a meter 100 that removes the necessity of pre-configuration of the communications module 140 or the necessity of requiring a redundant communication port on the communications module 140 solely for configuration in the module by allowing the meter's optical communication port 112 to pass-thru or relay communications to the configuration port 146/142 of the communication module while installed in a meter with the meter cover installed and even with the meter in service. The meter's optical port 112 allows baud rate and other communication parameters to be set to match the attached module 140. With communication to the module 140 established, the module 140 may then be configured and/or parameters or firmware updates may be downloaded into the module 140 without the need to remove the module 140 from the meter 100 or to take the meter out of service if it is already installed.

Although the present invention has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A utility meter adapted to communicate with a device external to the utility meter comprising:
a meter housing;
a first port and a second port provided in the utility meter, the first port adapted to receive signals transmitted from outside the meter housing;
a communications module connected to the second port, the communications module adapted to communicate with the device external to the utility meter; and
a processor connected to the first port and the second port, the processor configured to pass signals received at the first port to the communications module through the second port.

2. The utility meter of claim 1 wherein the first port provides a first means for receiving signals and the second port provides a second means for receiving signals, the first means for receiving signals different from the second means for receiving signals.

3. The utility meter of claim 1 wherein the first port is an optical port configured to receive optical signals transmitted from outside the meter housing.

4. The utility meter of claim 1 wherein the communications module is an automatic meter reader module.

5. The utility meter of claim 1 wherein the communications module is provided within the meter housing.

6. The utility meter of claim 1 wherein the processor is configured to pass signals received from the first port to the second port without parsing the signals received from the first port.

7. The utility meter of claim 1 wherein the signals received at the first port include configuration signals for the communications module.

8. The utility meter of claim 7 wherein the configuration signals are intended to set communication parameters within the communications module.

9. The utility meter of claim 8 wherein the communication parameters include at least one communication parameter selected from the group consisting of baud rate, data word length, and stop bits.

10. The utility meter of claim 7 wherein the configuration signals include firmware updates for the communications module.

11. The utility meter of claim 1 wherein the communications module includes a configuration port that is not connected to the second port.

12. A utility meter comprising:
a) a first port;
b) a second port;
c) a communications module connected to the second port;
d) a processor connected to the first port and the second port, wherein the processor is configured to operate in a first mode where the processor delivers metrology data to the communications module through the second port and a second mode where the processor passes configuration signals received at the first port to the communications module through the second port.

13. The utility meter of claim 12 wherein the first port is an optical port configured to receive signals transmitted outside of the utility meter.

14. The utility meter of claim 12 wherein the processor does not parse the configuration signals from the first port when passing the configuration signals to the second port.

15. The utility meter of claim 12 wherein the communications module is an automatic meter reader module.

16. The utility meter of claim 12 the configuration signals deliver communication parameters to the communication module, the communication parameters including at least one parameter selected from the group consisting of baud rate, data word length, and stop bits.

17. The utility meter of claim 12 further comprises a meter housing, wherein the communications module is provided within the meter housing.

18. A method of operating a utility meter including a first port and a second port, the first port configured to receive signals transmitted outside of the utility meter and the second port connected to a communications module, the method comprising:
a) delivering metrology data to the communications module through the second port;
b) sending the metrology data delivered to the communications module to a communications network; and
c) passing configuration signals received at the first port to the communications module through the second port, wherein the communications module is configured using the configuration signals.

19. The method of claim 18 wherein the configuration signals are optical signals received at the first port and converted into electrical signals passed to the second port.

20. The method of claim 18 wherein the utility meter comprises a microprocessor operating in a first mode when the metrology data is delivered to the communications module through the second port and operating in a second mode wherein the configuration signals are passed to the communications module through the second port, wherein metrology data is not delivered to the communications module when the microprocessor operates in the second mode.
